(19) United States
(12) Patent Application Publication
(10) Pub. No.: US 2025/0154030 A1
(43) Pub. Date: May 15, 2025

(54) Method and System for Electrochemically Remediating Contaminants in a Liquid

(71) Applicant: ACLARITY, INC., Mansfield, MA (US)

(72) Inventors: Orren David Schneider, Plainsboro, NJ (US); Anilkumar Krosuri, Raynham, MA (US)

(21) Appl. No.: 18/510,639

(22) Filed: Nov. 15, 2023

(51) Int. Cl. C02F 1/461; C02F 101/36

(52) U.S. Cl. CPC C02F 1/46109; C02F 2101/363; C02F 2201/4614; C02F 2201/4615; C02F 2209/06

(57) ABSTRACT

A method or system for electrochemically remediating a contaminant in a liquid includes combining a liquid including a water-soluble contaminant with an amount of conditioning agent sufficient to create a conditioned solution having a substantially neutral colloidal charge. The conditioned solution is delivered to a flow-through electrochemical reactor and an electrical current is applied to the flow-through electrochemical reactor to produce a first charged electrode and a second charged electrode. The first charged electrode and the second charged electrode are spaced apart from one another by an electroactive gap. The conditioned solution is flowed through the electroactive gap, thereby electrochemically remediating the water-soluble contaminant in the liquid.

### FIELD OF THE DISCLOSURE

The disclosure relates to liquid purification devices and more specifically to an electrochemical reactor for remediating contaminants in a liquid.

### BACKGROUND

The problems of pollution and contamination of water continue to grow. Often, consumer waste is disposed of in landfills or similar collection sites. Chemicals from the waste can leach down into the underlying soil and eventually reach and contaminate ground water. Chemical groundwater contamination can pose significant health risks to the general population surrounding the contamination.

With increasing occurrence of various microorganisms and anthropogenic pollutants in the environment, access to clean drinking water is a growing concern around the world. The quality of water available for potable use varies greatly depending on the source and active treatment processes. Varying characteristics of source waters make treatment processes difficult to control, let alone standardize. For example, various contaminants found in source waters have a range of differing properties, which dictate the type of treatment process used for removal or destruction (i.e., physical, biological, or chemical). As a result, the majority of commercialized water treatment systems do not have the physical and/or chemical capabilities to treat different water sources because the specific functionalities implemented for their specific source water may not be effective for other water sources (or even as quality changes occur in the targeted source(s)).

Furthermore, while some pollutants can break down into benign substances in a landfill, by exposure to biological agents, for example, other pollutants do not break down easily. Some examples of such pollutants that have recently been found in groundwater in significant quantities are poly- or perfluorinated alkyl substances (commonly referred to as “PFAS”). PFAS are durable chemicals having decay rates of essentially 0 under ambient conditions and exhibit good oil, water, temperature, chemical, and fire resistance. PFAS are found in a variety of consumer and industrial products, including but not limited to Teflon®, Scotchgard®, ski wax, clothing, cell phones, computers, tablets, semi-conductors, surgical gowns, commercial aircraft, low-emissions vehicles, and fire-fighting foams. As products containing PFAS reach the end of their useful life, they are often discarded in landfills. Because PFAS exhibits the beneficial qualities mentioned above, they are also very slow to degrade, and they are sometimes referred to as “forever chemicals” because it can take decades for these materials to degrade under ambient conditions.

While research on PFAS effects in humans is still being conducted, some potential health problems correlated with high PFAS levels in blood include increased cholesterol, decreased immune function, changes in liver enzymes, increases in blood pressure, and increases in some forms of cancer. PFAS can enter the blood stream in a number of ways, for example, by ingesting contaminated water, contaminated fish, poultry, or meat, contaminated soil or dust, or contaminated food wrapped or contained within packaging material that contains PFAS. Because of the potential harmful effects of PFAS, efforts are underway to mitigate the amount of PFAS in drinking water. One way to mitigate the amount of PFAS in drinking water is to reduce the amount of PFAS-containing materials disposed of in landfills. However, complete elimination of PFAS-containing materials is not feasible. However, PFAS that leaches into groundwater supplies may be effectively removed before or during treatment, for example, by a municipal water treatment plant, to make the water safer for consumption.

Currently, PFAS is most often removed from water by applying adsorption and filtration methods, such as activated carbon adsorption, ion exchange resin adsorption, and high-pressure (reverse osmosis or nanofiltration) membranes. However, current treatment methods are expensive, impractical for large scale treatment, can require high pressures, and can produce wastes containing very high concentrations of PFAS in waste streams. In addition, when activated carbon or ion exchange resins can no longer remove these compounds, they must be removed and are often incinerated as hazardous waste or are placed in landfills, thereby continuing the cycle of disposal and leaching.

Similar issues are raised by polychlorobenzenes (PCBs) and polycyclic aromatic hydrocarbons (PAHs) which also present industrial/hazardous waste issues and are difficult to remediate.

### SUMMARY OF THE DISCLOSURE

According to one example, a method of electrochemically remediating a contaminant in a liquid includes combining a liquid comprising a water-soluble contaminant with an amount of conditioning agent sufficient to form a conditioned solution having a substantially neutral colloidal charge; delivering the conditioned solution to a flow-through electrochemical reactor; and applying electrical current to the flow-through electrochemical reactor to produce a first charged electrode and a second charged electrode, the first charged electrode and the second charged electrode being spaced apart from one another by an electroactive gap, and flowing the conditioned solution through the electroactive gap, thereby electrochemically remediating the water-soluble contaminant in the liquid.

The foregoing example of a method of electrochemically remediating a contaminant in a liquid may further include any one or more of the following optional features, structures, and/or forms.

In some optional forms, the method further includes determining the amount of conditioning agent by combining a sample of the liquid comprising a water-soluble contaminant with the conditioning agent until the conditioned solution reaches a substantially neutral colloidal charge and then scaling the amount of conditioning agent needed to cause the conditioned solution to reach a substantially neutral colloidal charge to account for the amount of liquid comprising a water-soluble contaminant to be treated in the electrochemical reactor.

In other optional forms, the contaminant is negatively charged in an aqueous solution having a pH greater than about 3, for example, greater than about 4, greater than about 5, and/or greater than about 6.

In other optional forms, the substantially neutral colloidal charge is provided when a streaming current value is between about −30 and about +30, between about −20 and about +20, between about −10 and about +10, and more preferably between about −5 and about +5. Alternatively, the substantially neutral colloidal charge is provided when a zeta potential is between about −20 mV and about +20 mV, between about −10 mV and about +10 mV, and more preferably between about −5 mV and about +5 mV.

In other optional forms, the colloidal charge is measured, and the amount of conditioning agent sufficient to create a conditioned solution having a substantially neutral colloidal charge are determined by a coagulant charge analyzer.

In other optional forms, the coagulant charge analyzer includes a piston placed in an annular space through which the conditioned solution passes.

In other optional forms, the colloidal charge is measured by passing the conditioned solution through an electrode gap and applying a known electrical potential across the electrode gap and calculating a velocity of particles through a defined sensing zone.

In other optional forms, the conditioning agent includes a conditioning agent chosen from one or more in the group of a coagulant, a polymer, and a surfactant.

In other optional forms, the conditioning agent includes a positively charged polymer or a positively charged surfactant (e.g., the polymer or surfactant is positively charged when present in an aqueous solution having a pH greater than about 3, for example, greater than about 4, greater than about 5, and/or greater than about 6).

In other optional forms, the contaminant is highly water-soluble.

In other optional forms, the contaminant comprises PFAS.

In another optional form, the contaminant is chosen from one or more in the group of PCB, PAH, and PFAS.

In other optional forms, combining the liquid comprising a contaminant and the conditioning agent is carried out in a conditioning tank before delivering the conditioned solution to the flow-through electrochemical reactor.

In other optional forms, combining the liquid comprising a contaminant and the conditioning agent is carried out in a reactor tank, thereby preparing the conditioned solution in situ in the reactor tank including the flow-through electrochemical reactor.

In other optional forms, combining is carried out in the conditioning tank for a period of time greater than 30 seconds, for example, between 30 seconds and 60 minutes, or between 2 minutes and 20 minutes.

According to yet another example, an electrochemical contaminant remediation system includes a conditioning tank having an untreated liquid input and a conditioning agent input. The conditioning tank is configured to accept untreated liquid comprising a water-soluble contaminant from the untreated liquid input and conditioning agent from the conditioning agent input such that the untreated liquid and the conditioning agent are combined in the conditioning tank to form a conditioned solution in the conditioning tank, the conditioned solution having a substantially neutral colloidal charge. A conditioned fluid flow path fluidly connects the conditioning tank to a flow-through electrochemical reactor. The conditioned fluid flow path is configured to accept the conditioned solution from the conditioning tank and to deliver the conditioned solution to the flow-through electrochemical reactor. The flow-through electrochemical reactor includes a housing having an internal liquid flow-path, a first electrode disposed within the internal liquid flow-path, a second electrode spaced apart from the first electrode creating an electroactive gap between the first electrode and the second electrode. The flow-through electrode is configured to pass the conditioned solution through the electroactive gap and thereby electrochemically remediate the water-soluble contaminant.

According to yet another example, an electrochemical contaminant remediation system includes a reactor tank, the reactor tank including an untreated liquid input for accepting an untreated liquid comprising a water-soluble contaminant, a conditioning agent input fluidly connected to the reactor tank by a conditioning agent fluid flow path for accepting the conditioning agent, the reactor tank being configured to accept the untreated liquid comprising a water-soluble contaminant from the untreated liquid input and the conditioning agent from the conditioning agent input such that the untreated liquid and the conditioning agent are combined in situ in the reactor tank to form a conditioned solution, the conditioned solution having a substantially neutral colloidal charge, and a flow-through electrochemical reactor. The flow-through electrochemical reactor comprises a housing including an internal liquid flow-path, a first electrode disposed within the internal liquid flow-path, and a second electrode spaced apart from the first electrode creating an electroactive gap between the first electrode and the second electrode. The flow-through electrode is configured to pass the conditioned solution through the electroactive gap and thereby electrochemically remediate the water-soluble contaminant.

The foregoing examples of an electrochemical contaminant remediation system may further include any one or more of the following optional features, structures, method steps, and/or forms.

In one optional form, the conditioned solution comprises a colloidal charge of between about −30 and about +30, between about −20 and about +20, between about −10 and about +10, and more preferably between about −5 and about +5. Alternatively, the substantially neutral colloidal charge is provided when a zeta potential is between about −20 mV and about +20 mV, between about −10 mV and about +10 mV, and more preferably between about −5 mV and about +5 mV.

In another optional form, a coagulant charge analyzer is fluidly connected to the conditioning tank, the coagulant charge analyzer measuring the colloidal charge.

In another optional form, the coagulant charge analyzer comprises a piston placed in an annular space through which the conditioned solution passes.

In another optional form, the colloidal charge is measured by passing the conditioned solution through an electrode gap and applying a known electrical potential across the electrode gap and calculating a velocity of particles through a defined sensing zone.

In another optional form, the conditioning agent comprises a coagulant, a polymer, a surfactant, or combinations thereof.

In another optional form, the conditioning agent comprises a positively charged polymer or a positively charged surfactant (e.g., the polymer or surfactant is positively charged when present in an aqueous solution having a pH greater than about 3, for example, greater than about 4, greater than about 5, and/or greater than about 6).

In another optional form, the contaminant comprises PFAS.

In another optional form, the contaminant is chosen from one or more in the group of PCB, PAH, and PFAS.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a schematic drawing of an electrochemical reactor system according to the disclosure.

FIG. 2 is an exploded perspective view of an electrochemical reactor that may be used in the electrochemical reactor system of FIG. 1.

FIG. 3 is a side view of the electrochemical reactor of FIG. 2.

FIG. 4 is side cross-sectional view of the electrochemical reactor of FIG. 2.

FIG. 5 is a close-up side cross-sectional view of an inlet cap of the electrochemical reactor of FIG. 2.

FIG. 6 is a close-up side cross-sectional view of an outlet cap of the electrochemical reactor of FIG. 2.

FIGS. 7A and 7B are top and cross-sectional schematic views, respectively, of an alternate embodiment of an electrochemical reactor that may be used in the electrochemical reactor system of FIG. 1.

FIGS. 8A and 8B are cross-sectional schematic views, respectively, of yet another alternate embodiment of an electrochemical reactor that may be used in the electrochemical reactor system of FIG. 1.

FIG. 9 is a schematic drawing of an alternative embodiment of an electrochemical reactor system according to the disclosure.

FIG. 10 is a graphical representation of several examples of treatment results that were carried out at different concentrations of conditioning agent.

### DETAILED DESCRIPTION

The electrochemical reactors described herein are advantageously used for treatment of water including, but not limited to, producing potable water, treating municipal wastewater, treating commercial wastewater, treating domestic wastewater, and/or treating industrial wastewater. More specifically, the disclosed electrochemical reactors and systems described herein can be advantageously used to purify various types of water including wastewater (e.g., domestic wastewater, commercial wastewater, municipal wastewater, industrial wastewater), rain water, lake water, river water, ground water, for multiple end uses, and most significantly, to purify water intended for drinking. Thus, the methods and systems remediate contaminants in liquids that are predominantly aqueous solutions.

Electrochemical reactors for treating water work on their intended target contaminants by causing oxidation reactions to occur at the anode and/or reduction reactions to occur at the cathode. These redox reactions are intrinsically linked to one another in that electrons are removed from a species at the anode and essentially flow from the anode oxidizing, reactive, outer surface to the cathode reducing, reactive, outer surface where they are injected into another species. Typically, both oxidation and reduction reactions are considered to be desirable, or at least innocuous, in electrochemical reactors as both oxidation and reduction reactions can facilitate degradation of target contaminants.

The electrochemical reactors described herein are durable and scalable to meet relatively small personal or domestic demands as well as relatively large consumer, commercial, municipal, or industrial demands. Advantageously, the electrochemical reactors described herein can be manufactured without moving parts and therefore have long useful lives, while being relatively inexpensive and easy to manufacture. Moreover, the electrochemical reactors described herein surprisingly and unexpectedly can more efficiently treat/destroy contaminants present in the water/solution being treated, with significantly less waste being produced and with a simplicity of operation, particularly relative to existing systems that treat water including contaminants using advanced oxidation processes.

The systems and methods described herein are particularly useful for remediating persistent contaminants that are considered to be chemically stable and effectively have decay rates of essentially 0 under ambient conditions, such as PFAS including but not limited to PFOA, PFOS, PFHpA, PFHxS, PFPeA, and PFBS, particularly sulfonic acid PFAS species including but not limited to PFOS, PFHxS, and PFBS. The systems and methods described herein can also be used to effectively remediate other water-soluble negatively charged contaminants such as PCBs and PAHs.

While electrochemical remediation systems exist for the treatment of PFAS and other recalcitrant materials, they are generally limited by the mass transport of the contaminant to or proximate to the electrode surface. Once sorbed to and/or proximate to the electrode surface, these contaminants can undergo direct electron transfer reactions and are then partially or completely transformed to components including, but not limited to, carbon dioxide, fluoride, and sulfate, rendering them less harmful to the environment and human health. However, the rate of contaminant destruction by existing systems and methods is very slow and inefficient. The problem is particularly exacerbated for water-soluble contaminants, particularly highly water-soluble contaminants, which are readily dissolved in water and thus remain in solution such that there is little to no sorption to the electrode surface,

The systems and methods described herein increase the rate of mass transport of contaminants proximate to an electrode surface and/or extent of sorption to an electrode surface by including conditioning agents, and forming conditioning agent/contaminant complexes, thereby neutralizing the negative charge of the contaminant. Without intending to be bound by theory, it is believed that the formed conditioning agent/contaminant complexes are more hydrophobic, which allows the conditioning agent/contaminant complexes to come out of solution and sorb to the electrodes which advantageously and surprisingly increases the efficiency of the reactor, thereby improving throughput, performance, and/or reducing electrical requirements of the electrochemical reactor such as power and voltage.

As used herein, an electrochemical reactor refers to a reactor having a solution or fluid flow-path there through. The basic structural elements of an electrochemical reactor include a housing having an inlet, an outlet, one or more anodes, and one or more cathodes, as described and shown for example in US Patent Publication No. 2019/0284066, and in U.S. Patent Publication No. 2022/0073380, each of which are hereby incorporated by reference in their entirety.

The disclosed electrochemical reactors utilize electricity to effect water purification and/or contaminant remediation (and more specifically contaminant destruction). Specifically, contaminants, particularly various PFAS species, particularly sulfonic acid PFAS species, are oxidized on or near the anode surface in the electroactive gap, which remediates and destroys the contaminants. Surprisingly, contaminants such as poly or perfluorinated alkyl substances (PFAS), polychlorinated biphenyl (PCBs), and polycyclic aromatic hydrocarbons (PAHs) can be efficiently and rapidly oxidized on or near the anode surface when conditioned solutions as disclosed herein are treated in the electroactive gap of the disclosed electrochemical reactors, thereby transforming these unwanted contaminants, particularly PFAS species such as sulfonic acid PFAS species, to less harmful substances. Further, the electrodes employed are not consumed by the reactions, which drastically minimizes the maintenance requirements as well as the cost of replacement. As a result, fouling or scaling of the electrodes by agglomeration of organic matter, or by precipitation of metals, can advantageously be reversed by reversing the polarity of the electrodes, backwashing with water, increasing voltage, and/or by cleaning with an acid or base.

“About,” “approximately,” or “substantially” as used herein are inclusive of the stated value and means within an acceptable range of deviation for the particular value as determined by one of ordinary skill in the art, considering the measurement in question and the error associated with measurement of the particular quantity (i.e., the limitations of the measurement system). For example, “about,” “approximately,” or “substantially” can mean within one standard deviation, or within +10%, 5%, 3%, or 1% of the stated value.

“Carbonaceous” as used herein means a material that comprises carbon. To be considered “carbonaceous” as used herein, a material should contain carbon with carbon atoms in other than a +4 oxidation state (such that the carbon atoms are capable of being oxidized). For example, carbonaceous materials include, but are not limited to, graphite, graphene, fullerenes, electrically conductive plastics, and diamond.

In order for an electrochemical process (and thus for the disclosed electrochemical reactors) to operate, there must be two (or more) electrodes, generally opposed to one another with one or more functioning as an anode and one or more functioning as a cathode. “Electroactive gap” as used herein refers to a gap or space between corresponding pairs of electrodes functioning as the anode(s) and the cathode(s). In the disclosed flow-through electrochemical reactors, the electroactive gap is provided in the flow-path through which the solution, typically an aqueous phase including contaminants, to be treated and/or destroyed, may flow and electrons may be transferred when the electrodes of the electrochemical reactors are powered. The disclosed flow-through electrochemical reactors are adapted and arranged such that the current flow causes electrochemical reactions to take place within the electroactive gap that cause contaminants in the water/solution being treated to degrade and/or be rendered inactive, thereby purifying the water and even converting non-potable water to potable water and/or allowing a (previously) contaminated industrial effluent stream to be released to the environment.

“Dimensionally stable anode” as used herein (and as conventionally understood) refers to an anode that displays relatively high conductivity and corrosion resistance. Generally, dimensionally stable anodes are manufactured from one or more metal oxides such as RuO₂ (ruthenium oxide), IrO₂ (iridium oxide), SnO (tin oxide) and/or PtO₂ (platinum oxide).

“Mixed metal oxide electrodes” as used herein (which may, in certain embodiments disclosed herein, be used as the anode or as the cathode) are made by coating a substrate, such as a titanium metal substrate or a titanium expanded mesh, with a mixture of metal oxides. One or more oxides typically present is RuO₂ (ruthenium oxide), IrO₂ (iridium oxide), SnO (tin oxide) or PtO₂ (platinum oxide), for conducting electricity and catalyzing the desired reactions.

Electrodes can be cylindrical or plate-shaped. “Flow-through” electrodes as used herein refer to porous electrodes and “flow-by” electrodes refer to solid electrodes. In preferred embodiments, flow-through and flow-by electrodes may have an annulus shape,

“Water-soluble” as used herein refers to a solute (material, compound, or substance, typically a contaminant) having water solubility between about 10 and about 600 mg/L. “Highly water-soluble” as used herein refers to a solute (material, compound, or substance, typically a contaminant) having water solubility of greater than about 600 mg/l, more than about 1000 mg/L, and/or more than about 1500 mg/L dissolution of a given solute in water. Typically, the contaminants remediated herein, particularly PFAS species such as sulfonic acid PFAS species, are highly water-soluble which makes their electrochemical remediation more challenging as described herein.

“Conditioning agents,” as used herein, mean materials or mixtures of materials that are used to form a conditioning agent/contaminant complex, typically by charge neutralization, absorption, adsorption, or a combination thereof. More specifically, in the disclosed systems and methods, a contaminated liquid is cleaned or purified by the conditioning agent forming a complex with a contaminant material in the liquid. Thus, as used herein, conditioning agents are materials that combine, complex, sorb, interact, and/or bind with the contaminant molecule, typically PFAS. By combining with, or binding to, the contaminant molecule, without being bound by theory, it is believed that the conditioning agent/contaminant complex acquires increased hydrophobicity and insolubility, which causes the combined conditioning agent/contaminant moiety to be more easily transported proximate to and/or more completely adsorbed via hydrophobic interactions to an electrode surface. The adsorbed conditioning agent/contaminant molecules are then degraded and destroyed by electrochemical reaction on or proximate to the electrode surface, particularly the positively charged electrode (or anode) surface.

Conditioning agents useful in the apparatus and methods according to the disclosure can be categorized using one or more of four basic categories: polymers, including anionic polymers (e.g., polyanionic celluloses, or polyacrylamides also including acrylic acid salt monomeric units), and cationic polymers (e.g., a polyquaternium also known as a quaternary ammonium polymer such as Polyquaternium 6, which is also referred to as Polydiallyldimethylammonium chloride and PolyDADMAC, and polyquaternium 7; surfactants including cationic surfactants (e.g., a quaternary ammonium surfactant such as cetrimonium bromide); and coagulants (e.g., Ferric chloride (FeCl₃), ferric sulfate (Fe₂(SO₄)₃), alum/aluminum sulfate (Al₂(SO₄)₃), Polyaluminum chloride (PACl), and Aluminum chlorohydrate (ACH). PFAS (and other contaminants) may be removed from a liquid, such as water, by combining a liquid comprising the contaminant (e.g., PFAS) with a conditioning agent, for example, in a conditioning or reactor tank, to form a conditioned solution including contaminant/conditioning agent complexes. More specifically, a conditioning agent, such as a cationic polymer, a cationic surfactant, or a coagulant, for example, PolyDADMAC, cetrimonium bromide, Ferric chloride (FeCl₃), ferric sulfate (Fe₂(SO₄)₃), alum/aluminum sulfate (Al₂(SO₄)₃), Polyaluminum chloride (PACl), and/or Aluminum chlorohydrate (ACH), is mixed with contaminant containing water, such as PFAS contaminated water. The conditioning agent combines, complexes, sorbs, interacts, and/or binds with the PFAS molecules (or other chemically stable, relatively soluble chemical contaminant), for example, in a conditioning or reactor tank to form contaminant/conditioning agent complexes, and are theorized to more readily adsorb to and/or be transported such that they are proximate to an electrode surface of the electrochemical reactor, thereby facilitating electron transfer from/to the contaminant and electrochemical degradation/destruction thereof. Because electrostatic attraction is useful for forming the contaminant/conditioning agent complexes, positively charged moieties have been shown to have significant effects with respect to PFAS species which are often negatively charged, especially at pH values greater than about 3. It is believed that negatively charged moieties will have similar efficacy with respect to forming complexes with PFAS species that effectively enhance electrochemical remediation of PFAS species that are positively charged, for example, Ca-PFAS complexes.

“Substantially neutral colloidal charge” as used herein typically refers to a solution having a streaming current value of between about −30 and about +30, for example, between about −15 and about +15, between about −10 and about +10, and preferably between about −5 and about +5, as measured using a colloidal charge analyzer, or equivalent electrokinetic measurements of colloidal charge such as zeta potential. For example, alternatively, the substantially neutral colloidal charge is provided when a zeta potential is between about −20 mV and about +20 mV, between about −10 mV and about +10 mV, and more preferably between about −5 mV and about +5 mV.

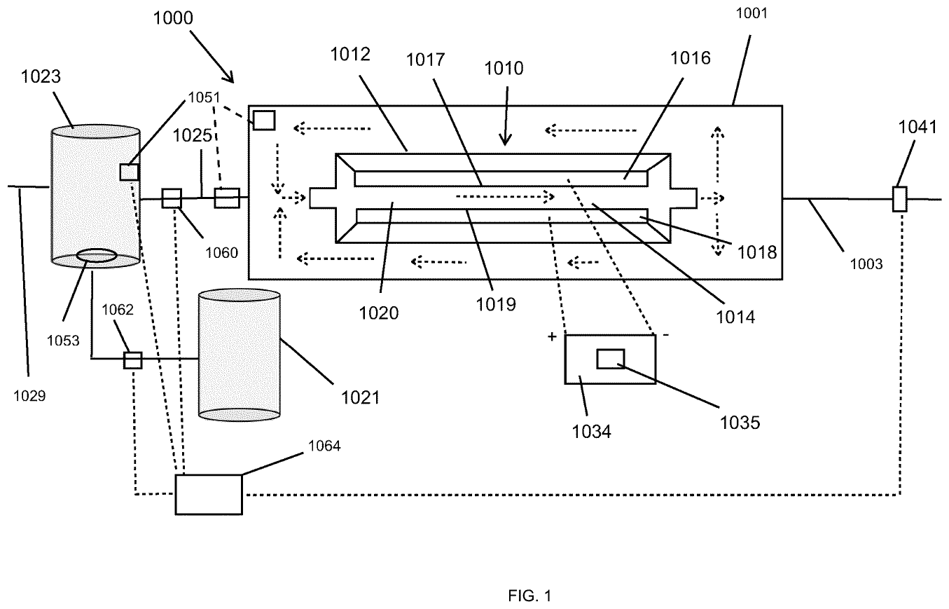

Turning now to FIG. 1, an electrochemical system 1000 includes an electrochemical reactor 1010 disposed in a reactor tank 1001. Although only one electrochemical reactor 1010 is illustrated in the reactor tank 1001, it should be understood that a plurality of electrochemical reactors 1010 may be and typically are located in the reactor tank 1001. The reactor tank 1001 includes an input 1002 and an output 1003. The electrochemical reactor 1010 comprises a housing 1012 having an internal fluid flow-path 1014. A cathode 1016 having an outer, reducing, reactive surface 1017 is disposed within the internal fluid flow-path 1014. An anode 1018 having an outer, oxidizing, reactive surface 1019 is also disposed within the internal fluid flow-path 1014. At least portions of the cathode 1016 outer, reducing, reactive surface and the anode 1018 outer, oxidizing, reactive surface are separated by an electroactive gap 1020 between the anode 1018 and the cathode 1016. In some embodiments, the electroactive gap 1020 is less than 25 cm and greater than 1 cm. In other embodiments, the electroactive gap is greater than 2 mm and less than 5 mm, for example, about 3 mm.

In embodiments, the oxidizing, reactive, outer surface 1019 of the anode 1018 is elemental titanium metal (e.g., not including any exterior facing coating), and the reducing, reactive, outer surface 1017 of the cathode 1016 is Ti₄O₇. In other embodiments, the anode 1018 comprises a mixed metal oxide, and the cathode 1016 comprises Ti₄O₇. In some embodiments, the anode 1018 comprises elemental titanium metal (e.g., not including any coating), and the cathode 1016 comprises elemental titanium carrying a coating. In further embodiments, the anode 1018 comprises a mixed metal oxide and the cathode 1016 comprises a mixed metal oxide.

A conditioning tank 1023 contains a water-soluble contaminant, typically a highly water-soluble contaminant that is negatively charged at pH values greater than about 3, greater than about 4, greater than about 5, and/or greater than about 6, and the conditioning tank 1023 is fluidly connected to the reactor tank 1001 and the electrochemical reactor by an input line 1025 to deliver a conditioned solution from the conditioning tank 1023 to the reactor tank 1001. Fluid from the reactor tank 1001 may be withdrawn through a reactor tank outlet line 1003. The water-soluble contaminant includes a contaminant chosen from one or more contaminants in the group of contaminants that are negatively charged at pH values greater than about 3, greater than about 4, greater than about 5, and/or greater than about 6, as described above, particularly, PAHs, PCBs, and poly or perfluorinated alkyl substances (PFAS), particularly sulfonic acid PFAS species, which are surprisingly remediated (and rendered harmless) as shown by the examples.

An agent tank 1021 can be fluidly connected to the conditioning tank 1023. Alternatively, the agent tank 1021 and the conditioning tank 2021 may be provided by the same structure. The agent tank 2021 holds a conditioning agent. Typically, the conditioning agent comprises one or more conditioning agents chosen from the group of a coagulant, a polymer, and a surfactant, as described above. Typically, the conditioning agent comprises a positively charged polymer or a positively charged surfactant, the positively charged polymer or positively charged surfactant having a positive charge at a pH value greater than about 3, greater than about 4, greater than about 5, and/or greater than about 6. As illustrated, the conditioning agent is combined with the water-soluble contaminant in the conditioning tank 1021, thereby forming the conditioned solution. Alternatively, as described below, the conditioning agent can be combined with the water-soluble conditioning agent in a reactor tank 1001, but this is generally less preferred, as formation of the conditioned solution, or more specifically the contaminant/conditioning agent complexes, may not occur as comprehensively prior to introduction into the electrochemical reactors 1010 (relative to use of the conditioning tank 1023). The conditioning agent is added to the conditioning tank 1023 until the conditioned solution has a substantially neutral colloidal charge. The conditioned solution in the conditioning tank 1023 may be held for a period of time, for example, between 30 seconds and 60 minutes, more particularly between 2 minutes and 20 minutes, to ensure full mixing and complete chemical interactions between the water-soluble contaminant and the conditioning agent so as to neutralize the charge of the contaminant and form relatively hydrophobic contaminant/conditioning agent complexes. Optionally, a mixing device 1053, such as a stirring rod, a pump, or other mixing device, may be disposed in the conditioning tank 1023 to facilitate mixing of the conditioning agent with the contaminant. In some embodiments, the mechanical mixing device 1053 may comprise rotating paddle, fan, or impeller blades. In other embodiments, the mixing device 1053 may comprise a flow-through mixing device, such as a venturi. In other embodiments, the mixing device 1053 may comprise a bubble aerator. In other embodiments, the mixing device 1053 may comprise a hydraulic mixing device.

Optional control valves 1060, 1062 may control the flow of conditioned liquid to the agent tank 1001 and/or of conditioning agent from the agent tank 1021 to the conditioning tank 1023. The control valves 1060, 1062 may be connected to a controller, such as a processor 1064, that sends control signals to the control valves 1060, 1062 based on time measurements, user commands, and/or inputs from sensors, such as a conditioned solution colloidal charge analyzer 1051 in the conditioning tank 1023 and/or from other sensors, such as a colloidal charge sensor 1041 (which is discussed further below) either in the reactor tank 1001, or downstream of the reactor tank 1001. The sensors 1051, 1041 may be wirelessly connected to the processor 1064, or the connections may be wired (not shown). In other embodiments, the coagulant charge analyzer 1051 may be located in one or more of the positions illustrated in FIG. 1. For example, the coagulant charge analyzer 1051 may be located in the conditioning tank 1023, between the conditioning tank 1023 and the reactor tank 1001, and/or in the reactor tank 1001. It should be noted that the terms “colloidal charge analyzer” and “colloidal charge sensor” are used interchangeably, and both refer to a sensor capable of providing an electrokinetic measurement of the colloidal charge of a solution in real time.

For example, the conditioned solution charge analyzer 1051, and the colloidal charge sensor 1041 may comprise any apparatus that measures the charge of a colloidal solution, or the zeta potential of a solution. Some examples of colloidal charge analyzers and conditioned solution charge analyzers that may be used in the systems and methods described herein include, but are not limited to, U.S. Pat. No. 5,059,909 entitled “Determination of Particle Size and Electrical Charge,” U.S. Pat. No. 6,553,949 entitled “Electrodynamic Particle Size Analyzer,” and U.S. Pat. No. 4,907,453 entitled “Colloid Analyzer,” each of which is incorporated by reference herein.

In other embodiments, the conditioning agent may further comprise heat transfer, in combination with one or more conditioning agents chosen from the group of a coagulant, a polymer, and a surfactant. For example, a cooling jacket may cool the solution in the conditioning tank to enhance formation of the conditioned solution. While it is generally understood that heat increases chemical reactions, the inventor found, counterintuitively, that cooling the solution containing the water-soluble contaminant enhances destruction of the contaminant (e.g., PFAS) in a flow-through electrochemical reactor. In other embodiments, the untreated liquid may be cooled by a cooling device before delivery to the mixing tank. While cooling alone can increase destruction of the contaminants using the systems and methods described herein, adding a further conditioning agent in the disclosed cooling systems and methods for remediating contaminants in liquids significantly increases destruction of the contaminants relative to cooling alone.

The colloidal charge of the conditioned solution may be measured by the conditioned solution charge analyzer 1051, which may comprise a piston placed in an annular space through which conditioned solution passes. The measurement may be taken in the conditioning tank 1023, or between the conditioning tank 1023 and the reactor tank 1001. In other embodiments, a zeta potential analyzer or an electrophoretic mobility analyzer may measure the colloidal charge. In some embodiments, the zeta potential analyzer or electrophoretic mobility analyzer may comprise passing the conditioned solution through an electrode gap and calculating a velocity of particles through a defined sensing zone.

In other embodiments, the solution containing the water-soluble contaminant may be combined with an acid, which is added to the conditioning tank 1023 until the pH of the conditioned solution so as to ensure the contaminant is charged. Typically, the pH may be greater than 3, which is generally low enough to ensure PFAS species are in their respective ionic forms in aqueous solution.

In some embodiments, such as the embodiment illustrated in FIG. 1, either the anode 1018 or the cathode 1016 may be in the form of a substantially flat plate, or both the anode 1018 and the cathode 1016 may be in the form of a substantially flat plate. In other embodiments, the anode 1018 and the cathode 1016 may take other shapes, such as concentric cylinders, as described below.

In some embodiments, an optional pre-filter (not shown) may be installed upstream of electrodes, the pre-filter may capture particles or various inorganic or organic materials thereby preventing the particles from creating potentially short circuiting bridges between electrodes.

A power supply 1034 is electrically coupled to the anode 1018 and to the cathode 1016, such that electrons flow from the anode 1018 to the cathode 1016. The power supply 1034 can be operated in any fashion, for example, at a substantially constant voltage or at a substantially constant amperage. Whereas most electrochemical systems operate in constant amperage mode, such that the voltage is allowed to vary as the conductivity of the water changes, the electrochemical reactors described here preferably are advantageously operated in a substantially constant voltage mode. Thus, as illustrated, an optional voltage regulator 1035 may be electrically coupled to the power supply 1034. The voltage regulator 1035 controls voltage of the power supply 1034. The voltage regulator 1035 may be integrally formed with the power supply 1034, or the voltage regulator 1035 may be a separate element operationally connected to the power supply 1034. Generally, the voltage can be set in a range between 4.0 volts and about 4.45 volts. Of course, the controlled voltage operation range can change based on numerous system parameters including but not limited to the specific electrodes, pH concentration, and conditioning agent concentration, as well as the target contaminant that is intended to be remediated with the electrochemical reactor.

The contaminant and the conditioning agent combine, complex, sorb, interact, and/or bind together in the conditioning tank 1023 to produce a conditioning agent/contaminant complex and the conditioning agent/contaminant complex has a substantially neutral colloidal charge. It is theorized that this strategy is particularly advantageous for contaminants like PFAS that have appreciable solubility in most solvents/solutions and therefore will not be adsorbed and/or be transported proximate to the electrode surface in appreciable amounts needed to accomplish effective electrochemical treatment using conventional electrochemical reactors.

As illustrated in FIG. 1, after the conditioned solution in the conditioning tank 1023 has reached a substantially neutral colloidal charge, the conditioned solution is delivered to the reactor tank 1001. Generally, there are more than one electrochemical reactor 1010 in the reactor tank 1001, but for simplicity only one is shown in FIG. 1. As the electrochemical reactors 1010 are started, the conditioned fluid flows through the electrode gaps 1014 and optionally can be recirculated within the reactor tank 1001 via a recirculation pump in order to travel through the electrode gaps 1014 again, as generally illustrated by the dashed arrows in FIG. 1.

A colloidal charge sensor 1041, similar to the colloidal charge sensors described above, may be located downstream of the reactor tank 1001. The colloidal charge sensor 1041 may measure the colloidal charge of the conditioned solution directed outwardly from the reactor tank 1001. The colloidal charge of the conditioned solution directed outwardly from the reactor tank 1001 should be substantially neutral. If the colloidal charge of the conditioned solution that exits from the reactor tank 1001 is not substantially neutral, it is an indication that the conditioning agent may be breaking down or decomposing in the electrochemical reactor 1010. To remedy the breakdown of the conditioning agent, a signal may be sent from the colloidal charge sensor 1041 to the agent tank 1021 to release more conditioning agent into the conditioning tank 1023 (or the reactor tank) to make up for the conditioning agent lost, presumptively due to degradation attributable to the electrochemical reactor 1010.

Conventional chemical oxidants are not strong enough to break the carbon-fluorine chemical bonds in PFAS molecules. Moreover, PFAS molecules are hydrophilic and highly water-soluble as described herein. Surface contact oxidation on the anode surface is needed to supply electrons energetic enough power to break the carbon-fluorine chemical bonds in the PFAS molecules to remediate and/or destroy these molecules and render them substantially harmless. Generally, conventional wisdom would suggest that the negatively charged dissolved PFAS molecule would be attracted to the positively charged anode surface, such that the dissolved PFAS molecule would be electrostatically attracted thereto and destroyed. However, in practice, the inventors of this application have discovered that the dissolved PFAS molecules are not destroyed in significant numbers, even at higher power settings. Without being bound by theory, it is believed that the water-solubility and hydrophilic nature of the dissolved and negatively charged PFAS molecules makes it extremely difficult to get the dissolved PFAS molecules close enough to (or to contact) the anode surface to be oxidized effectively, as the dissolved PFAS molecules “prefer” to stay dissolved in the conditioned solution, rather than to adsorb to the anode surface. It is believed that favorable hydrogen bonding interactions in solution prevent or hinder adsorption of the dissolved and negatively charged PFAS molecules to the anode surface.

While conventional thinking would point to the negative charge of the dissolved and negatively charged PFAS molecule drawing the PFAS molecule to the positively charged anode due to the favorable electrostatic interactions in solution, the inventors of the instant application have found that counterintuitively, the electrostatic interactions (i.e., the negatively charged PFAS and the positively charged anode) do not predominate. Instead, the hydrophilic nature and high water-solubility of the dissolved PFAS molecule must be overcome in order to provide sufficient electrochemical remediation of these persistent contaminants. As a result, counter to conventional thinking, the inventors of the application discovered that neutralizing the negative charge of the dissolved PFAS contaminants and concomitant formation of the contaminant/conditioning agent complexes effectively causes the PFAS to become more hydrophobic and to more readily adsorb to the anode surface, where the high energy electrons can break the carbon-fluorine chemical bonds of the PFAS. Enhancement of electrochemical destruction of highly water-soluble contaminants by neutralizing the charge of a water-soluble contaminant molecule and treating the formed contaminant/condition agent complex is a counterintuitive and completely unexpected result.

Again, while not being held to theory, the inventors believe that the dissolved PFAS forms complexes with the conditioning agent, the complexes having a substantially neutral colloidal charge, and the complexes then comes out of solution, at least partially, and enhances adsorption to the anode surface, thereby enhancing destruction of the PFAS. More specifically, the complex neutralizes the native charge of PFAS in solution having pH>3, and the complex becomes much more hydrophobic, which is believed to enhance adsorption of the PFAS to the anode surface. Similar considerations apply to PCBs and PAHs.

This destruction technique has been found to be particularly advantageous for destruction of sulfonic acid PFAS species, and even more effective for shorter chain PFAS molecules like PFOA (at least relative to electrochemical treatment without forming a conditioned solution including a contaminant/conditioning agent and having substantially neutral colloidal charge).

Generally, the purpose of adding the conditioning agent is to alter the surface charge of particles and dissolved species. By moving the charge closer to zero, it is believed that hydrophobic interactions allow the PFAS to adsorb to the electrode surfaces, particularly to the anode. PFAS species generally have charges, but acid and bases can be added to ensure formation of the ionic form of PFAS as needed. An alternative method of neutralizing the colloidal charge is to lower the pH below the pKa of the PFAS species, which will cause the PFAS species to become protonated and come out of solution, which will allow sorption to the electrode (typically the anode), similar to the description above. Thus, in some embodiments, an acid can be added as a conditioning agent.

It is surprising that electrochemical oxidation is successful and more surprising that a technique for effecting flocculation and thus removal of colloids by sedimentation and/or filtration, can be applied to increase the efficiency of the treatment of highly water-soluble charged contaminants such as PFAS.

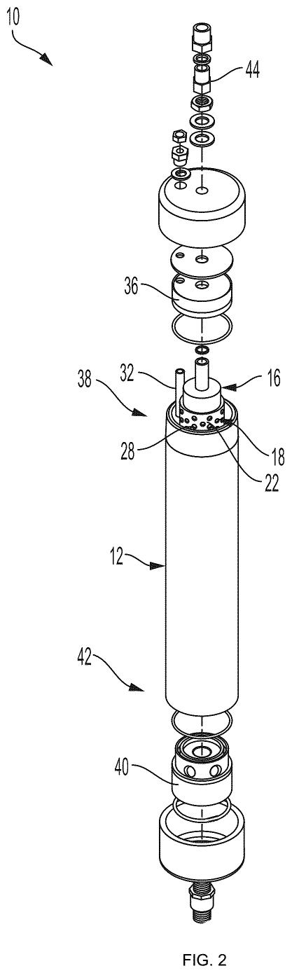

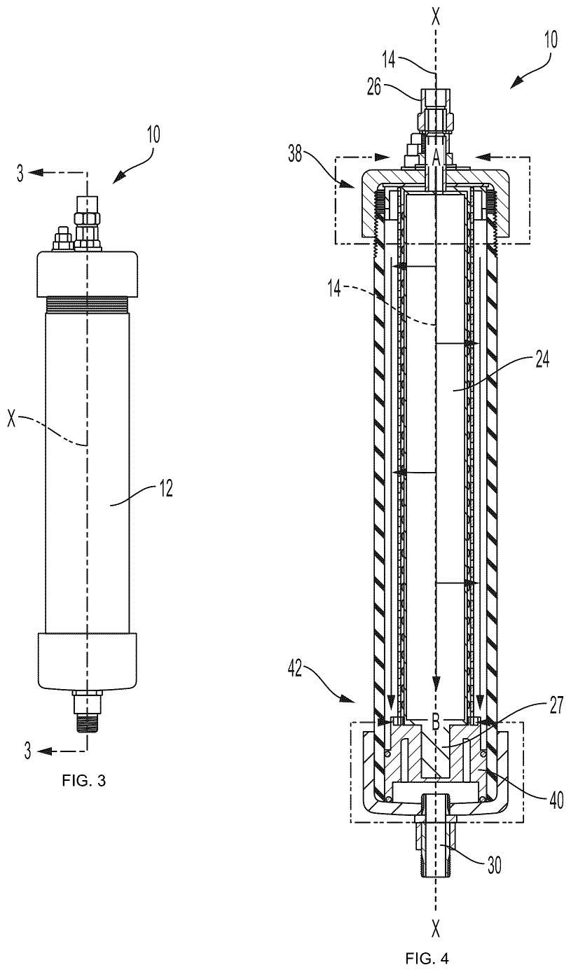

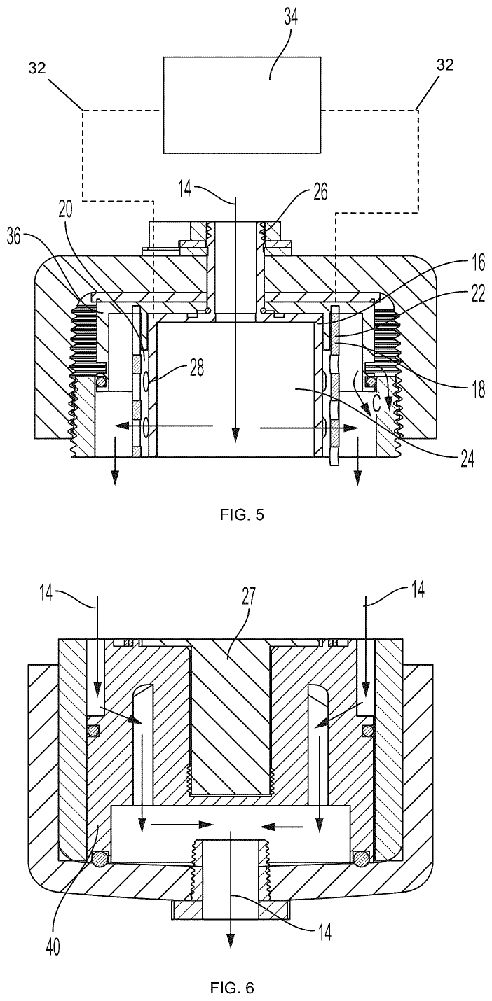

Turning now to FIGS. 2-6, an additional exemplary electrochemical reactor 10 is illustrated that may be used in the electrochemical contaminant remediation system 1000 of FIG. 1 in lieu of or in combination with electrochemical reactor 1010. Other examples of electrochemical reactors described herein may also be used as alternatives in the electrochemical contaminant remediation system 1000 of FIG. 1.

Referring again to FIGS. 2-6, the illustrated electrochemical reactor 10 includes a housing 12 having a fluid flow-path 14. A flow-through or solid first electrode, such as an anode 16, is disposed within the fluid flow-path 14. In the illustrated embodiment, the anode 16 is annulus-shaped and comprises a hollow cylinder, comprising a porous material or perforations or apertures. Such modified anodes 16 can advantageously permit radial flow within the housing 12.

A second electrode, such as a cathode 18, is spaced apart from the anode 16, thereby creating an electroactive gap 20 between the cathode 18 and the anode 16. In some embodiments, the electroactive gap 20 is less than 5 mm and greater than 2 mm. For example, in some embodiments, the electroactive gap is about 3 mm. In the illustrated embodiment, the cathode 18 is concentrically arranged about the anode 16. In embodiments where the cathode 18 or the anode 16 comprise porous walls, the porous wall can be provided by a cylinder comprising a porous material or by a cylinder with perforations or apertures as shown in the illustrated embodiment. In both instances, radial flow through the cathode 18 is possible. As mentioned above, the concentric arrangement of the cathode 18 and the anode 16 may also be reversed.

The anode 16 and/or the cathode 18 may further comprise a catalytic coating. The catalytic coating may be between 1 μm and 30 μm thick, preferably between 5 μm and 20 μm, and more preferably between 10 μm and 20 μm. The catalytic coating may comprise a metal chosen from one or more in the group of ruthenium (Ru), rhodium (Rh), palladium (Pd), iridium (Ir), platinum (Pt), and tantalum (Ta). For example, the catalytic combination may comprise a combination of Ru and Ta, a combination of Rh and Ta, a combination of Pd and Ta, a combination of Ir and Ta, a combination of Pt and Ta, a combination of Ru and Ir, a combination of Rh and Ir, a combination of Pd and Ir, or a combination of Pt and Ir.

As illustrated in FIGS. 2-6, both the cathode 18 and the anode 16 have a hollow cylindrical shape. The cathode 18 and the anode 16 are arranged concentrically, the anode 16 being located within a cylindrical wall 22 of the cathode 18. In the illustrated embodiment of FIGS. 2-6, the concentrically arranged cathode 18 and anode 16 share a common longitudinal axis x. An interior 24 of the anode 16 forms an initial flow-path for the water/solution to be treated that enters the housing 12 through an inlet 26. As the water/solution to be treated fills the interior 24, it flows longitudinally, parallel to the longitudinal axis x and eventually reaches the bottom of the interior 24 where the liquid is stopped by a plug 27. Once stopped, pressure builds up in the interior 24, which forces the liquid to flow radially outward, perpendicular to the longitudinal axis x, and over the wall of the anode 16 such that it can now access the electroactive gap 20 between the cathode 18 and the anode 16. The liquid may pass through the wall of the cathode 18 through porous openings in the cathode 18, or through apertures or perforations in the cathode, allowing treated fluid to be appropriately directed via an outlet 30.

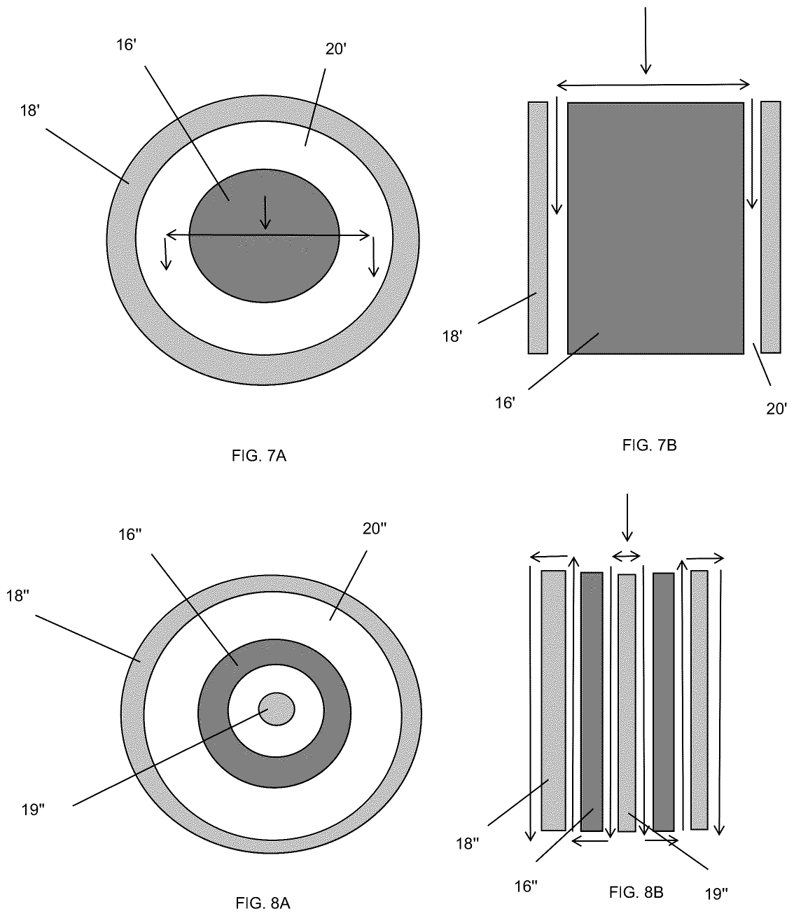

In other embodiments, for example as illustrated in FIGS. 7A and 7B, the anode 16′ comprises a solid cylinder, as the liquid enters through the inlet (not shown in FIGS. 7A and 7B), the fluid flows (represented by arrows in FIGS. 7A and 7B) over an outer surface of the anode cylinder 16′, thereby accessing the electroactive gap 20′ between the outer surface of the anode 16′ (which serves as an outer, oxidizing, reactive surface) and an inner surface of the cathode 18′ (which serves as an outer, reducing, reactive surface) proximate to the inlet. Thereafter, the liquid flows between the cathode 18′ and the anode 16′, through the electroactive gap 20′.

In yet other embodiments, for example as illustrated in FIGS. 8A and 8B, the anode 16″ comprises a hollow cylinder with a solid wall, a first cathode 18″ comprising a hollow cylinder with a solid wall is disposed concentrically and outside of the anode 16 and a second cathode 19″ optionally disposed within the hollow annular space defined by the anode 16″ solid wall. In this embodiment, the liquid flows (represented by the arrows in FIGS. 8A and 8B) across the top of the second cathode 19″, then downward, through the hollow annular space of the anode 16″ between the solid anode 16″ wall and the second cathode 19″ until reaching a bottom of the interior, where the liquid is stopped and forced to flow laterally outwards around a bottom end of the solid anode 16″ wall and then upwards through the electroactive gap between an outer surface of the solid anode 16″ wall (which serves as an outer, oxidizing, reactive surface) and an inner surface of the first cathode 18″ (which serves as an outer, reducing, reactive surface). The fluid may then be collected and/or otherwise directed for further treatment and/or use. Optionally, the fluid flow may further continue around a top of the first cathode 18″ and then downwardly to the bottom of the electrochemical reactor as illustrated in FIG. 8B.

Regardless, in the illustrated embodiments, once the liquid flows through, over, and/or around the wall of the anode 16, 16′, 16″, the liquid will be in the electroactive gap 20. When in the electroactive gap 20, chemical reactions take place in the liquid, which are driven by the electron flow supplied by the powered cathode 18, 18′, 18″ and anode 16, 16′, 16″. The liquid continues to flow between the cathode 18, 18′, 18″ wall 22 and the anode 16, 16′, 16″ wall. Eventually, the liquid flows out of the electroactive gap 20, such that the treated liquid can be collected and/or otherwise directed for further treatment and/or use.

In embodiments, both the cathode 18, 18′, 18″ and the anode 16, 16′, 16″ may comprise solid cylindrical walls. Referring again specifically to FIGS. 2-6, the solution flow-path may enter the hollow interior of the anode 16, flow downward until contacting the plug 27, then around a bottom end of the anode 16, through a gap between a bottom of the anode 16 wall and the plug 27, then upward through the electroactive gap 20 between the anode 16 and cathode 18 until contacting an inlet cap 36 and through a gap between the inlet cap 36 and the top end of the cathode 18, then downward on the outside of the cathode 18 to the outlet.

A power source 34 is connected to the cathode 18 and to the anode 16 via an electrical connection 32. The power source 34 ultimately supplies DC power to the anode 16 and to the cathode 18. The power source 34 may directly supply DC power, or the power source 34 may convert AC power to DC, for example with a transformer rectifier, before supplying the cathode 16 and the anode 18. In use, the power source 34 charges the cathode 18 and the anode 16 and water/solution being treated fills the electroactive gap 20, such that electrons flow between the cathode 18 and the anode 16 so as to drive certain desirable chemical reactions. The power source 34 may include, or be connected to, a voltage regulator (not shown in FIG. 2-6), as discussed above with respect to FIG. 1.

The inlet cap 36 is disposed at a first end 38 of the housing 12, the inlet cap 36 maintains proper spacing and orientation of the cathode 18 relative to the anode 16. An outlet guide flow cap 40 is disposed at a second end 42 of the housing 12. The outlet guide flow cap 40 seals the second end 42 of the housing 12 and receives outlet flow from the exterior of the cathode 16. The outlet guide flow cap 40 also seals one end of the interior 24 of anode 16 in conjunction with the plug 27.

An adapter base inlet 44 is disposed at the first end 38 of the housing 12, the adapter base inlet 44 providing plumbing and electrical connections while maintaining a pressure seal.

The cathode 16 may comprise carbonaceous materials, dimensionally stable anodes (DSA), titanium metal, Magneli-phase titanium oxide (of general formula TiₙO₂ₙ₋₁, for example Ti₄O₇), mixed metal oxides (including one or more of RuO₂ (ruthenium oxide), IrO₂ (iridium oxide), SnO (tin oxide) and PtO₂ (platinum oxide)), or boron doped diamond (BDD), or a combination thereof. As used herein, the term “Magneli-phase titanium oxide” refers to a titanium oxide having general formula TiₙO₂ₙ₋₁, for example, Ti₄O₇, Ti₅O₉, Ti₆O₁₁, or a mixture thereof. In an embodiment, the Magneli-phase titanium oxide may be Ti₄O₇. In other embodiments, the Magneli-phase titanium oxide may be a mixture of Magneli-phase titanium oxides. In a preferred embodiment, the cathode comprises Ti₄O₇ or elemental titanium and has a reducing, reactive surface comprising Ti₄O₇ or elemental titanium.

The anode 18 may comprise one of elemental titanium, dimensionally stable anodes (DSA), Magneli-phase titanium oxide (of general formula TiₙO₂ₙ₋₁, for example Ti₄O₇), mixed metal oxides (such as RuO₂ (ruthenium oxide), IrO₂ (iridium oxide), SnO (tin oxide) or PtO₂ (platinum oxide)), boron doped diamond (BDD), others, or a combination thereof. In a preferred embodiment, the anode 18 comprises an oxidizing, reactive surface comprising elemental titanium.

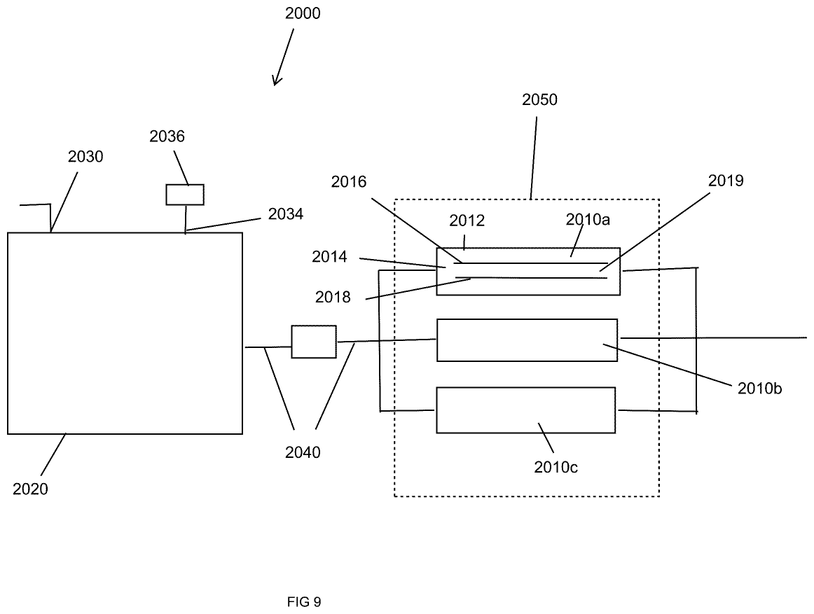

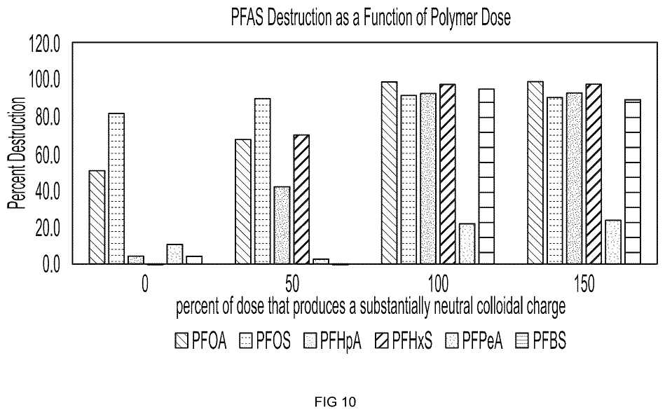

While certain elements, such as the inlet cap 36, outlet guide flow cap 40, and adapter base inlet 44, among others, are illustrated and described with respect to the illustrated electrochemical reactor embodiments of FIGS. 2-6, such elements are not required in the systems illustrated in FIGS. 1 and 10. To the contrary, the electrochemical reactors in the system embodiments illustrated in FIGS. 1 and 10 only require an anode and a cathode separated by an electroactive gap, as described above. While the electrochemical reactors illustrated in FIGS. 2-6 may be used in the systems illustrated in FIGS. 1 and 9, other electrochemical reactors may also be used and the figures and illustrations of the electrochemical reactors herein are merely examples and are not meant to be limiting.

Turning now to FIG. 9, another embodiment of an electrochemical contaminant remediation system 2000 is schematically illustrated that includes a conditioning tank 2020. Any features described in the embodiment of FIG. 1 may be included in the embodiment of FIG. 10. For example, the sensors 1041, 1051, and the control valves 1060, 1062 described above may be incorporated in the embodiment of FIG. 10, but are not shown or discussed for the sake of brevity.

The conditioning tank 2020 has an untreated liquid input 2030 and a conditioning agent input 2034. The conditioning tank 2020 is configured to accept and contain an untreated liquid from the untreated liquid input 2030 and a conditioning agent from the conditioning agent input 2034. The untreated liquid includes a water-soluble contaminant, typically a highly water-soluble contaminant that is negatively charged at pH values greater than about 3, greater than about 4, greater than about 5, and/or greater than about 6. The conditioning agent input 2034 is operatively connected to a source of conditioning agent 2036. Conditioning agents may be selected from the conditioning agents listed above. The untreated liquid and the conditioning agent are combined and/or mixed in the conditioning tank 2020 to produce a conditioned solution in the conditioning tank 2020. In some embodiments, the conditioning tank 2020 may include a mixing device (not shown in FIG. 10), such as a mechanical mixing device. In some embodiments, the mechanical mixing device may comprise rotating paddle, fan, or impeller blades. In other embodiments, the mixing device may comprise a flow-through mixing device, such as a venturi or a static mixer. In other embodiments, the mixing device may comprise a bubble aerator. In other embodiments, the mixing device may comprise a hydraulic mixing device or may rely on turbulence from pumps or other conveyance devices.

A conditioned fluid path 2040 fluidly connects the conditioning tank 2020 to a plurality of flow-through electrochemical reactors 2010a, 2010b, 2010c. In the embodiment of FIG. 2, the flow-through electrochemical reactors 2010a, 2010b, 2010c are connected in parallel to the liquid flow path 2040. Increasing the number of electrochemical reactors 2010a, 2010b, 2010c is another way to increase throughput of the system. More or fewer flow-through electrochemical reactors 2010a, 2010b, 2010c, may be used in any embodiment. For example, 2, 4, 5, 6, 10, 20, or more flow-through electrochemical reactors may be used in the system. Furthermore, some or all of the flow-through electrochemical reactors may be connected in series. In other embodiments, some flow-through electrochemical reactors may be connected in series while other flow-through electrochemical reactors may be connected in parallel. In some embodiments, two or more of the flow-through electrochemical reactors may be further enclosed in an optional external housing 2050, thereby potentially obviating the need for individual conditioned fluid paths 1040, 2040 to each electrochemical reactor 2010a, 2010b, 2010c. Alternatively, there is no need for individual conditioned fluid paths, and a single conditioned solution input may be used in a reactor tank (generally corresponding to 2050) including the electrochemical reactors. Still further, in other embodiments, one or more of the reactor housings 2012 of the electrochemical reactors 2010a, 2010b, 2010c may include a plurality of electrode pairs.

The conditioned fluid flow path 2040 is configured to accept the conditioned solution from the conditioning tank 2020 and to deliver the conditioned solution to the flow-through electrochemical reactors 2010a, 2010b, 2010c. Similar to the embodiment of FIG. 1, the flow-through electrochemical reactors 2010a, 2010b, 2010c include a housing 2012 having an internal liquid flow-path 2014, a first electrode 2016 disposed within the internal liquid flow-path 2014, and a second electrode 2018 spaced apart from the first electrode 2016 creating an electroactive gap 2019 between the first electrode 2016 and the second electrode 2018.

The conditioned solution passes through the electroactive gap 2019. The conditioned solution includes the conditioning agent, which comprises a material that combines, complexes, sorbs, interacts, and/or binds with the contaminant to produce a conditioning agent/contaminant complex and without being bound by theory it is believed that the hydrophobic nature of the conditioning agent/contaminant complex facilitates sorption to a surface of the first electrode 2016 (corresponding to an anode, as described above).

Once an appropriate electrochemical reactor is constructed and arranged, the power is applied to the cathode(s) and the anode(s), and fluid to be treated is passed through the electrodes resulting in electrochemical purification thereof. The purified fluid is subsequently removed/directed/collected from the outlet of the electrochemical reactor. The applied power may be reversed periodically to prevent passivation of the electrodes and to remove foulants. In other embodiments, the reactor may be periodically backwashed to purge built up solids that may have accumulated in the pores or openings of the electrode.

The electrochemical reactor system, according to any embodiment, may further optionally include an oxidation-reduction potential sensor, a pH sensor, a chlorine sensor, a conductivity sensor, a flow rate sensor, a pressure sensor, a temperature sensor, one or more contaminant sensors (such as nitrogen, TOC, UV-Vis, etc.), or a combination thereof.

Some advantages for using the disclosed electrochemical reactors are high corrosion resistance to acidic and basic solutions, high electrical conductivity, increased mass transfer, long electrode life, and electrochemical stability. Other advantages include easily disposable byproducts of the reactions, and small and efficient reactor systems.

In use, water treatment includes providing an electrochemical reactor, such as the electrochemical reactor 10, 1010 described above. Power is supplied to the cathode 16 and to the anode 18 by a power supply 34, 1034, such that electrons flow from the cathode 16 to the anode 18. The voltage regulator 1035 is operably connected to the power supply 34, 1034. The voltage applied by the power supply 34, 1034 is controlled with the voltage regulator 1035.

As the fluid containing the contaminant 1023 flows through the electroactive gap 20, 1020, turbulence can be advantageously created by mixing, for example with one or more paddles, within the electroactive gap 20, 1020 which enhances mixing and electrochemical remediation of the contaminants at the anode.

Turning now to FIG. 10, tests were done to observe the efficacy of the conditioning agent. The dose of conditioning agent required to produce a substantially neutral colloidal charge was determined, which will be referred to hereinafter as the “full dose.” Thereafter, four tests were run. The first test is the control test, which did not include any conditioning agent. This example had a streaming current measurement of about −50. The next test was run with 50% of the full dose to attain substantially neutral colloidal charge. This example had a streaming current measurement of about −30. The third test was run with 100% of the full dose to attain substantially neutral colloidal charge. This example had a streaming current measurement of about 0. And the fourth test was run with 150% of the full dose to attain substantially neutral colloidal charge. This example had a streaming current measurement of about +30. The results clearly show that for most PFAS species, the full dose drastically increased the percentage of destruction, while overdosing (more than 100%) did not produce any further benefit.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of electrochemically remediating a contaminant in a liquid, the method comprising:
combining a liquid comprising a water-soluble contaminant with an amount of conditioning agent sufficient to create a conditioned solution having a substantially neutral colloidal charge;
delivering the conditioned solution to a flow-through electrochemical reactor;
applying electrical current to the flow-through electrochemical reactor to produce a first charged electrode and a second charged electrode, the first charged electrode and the second charged electrode being spaced apart from one another by an electroactive gap; and
flowing the conditioned solution through the electroactive gap, thereby electrochemically remediating the water-soluble contaminant in the liquid.

2. The method of claim 1, further comprising determining the amount of conditioning agent by combining a sample of the liquid comprising a water-soluble contaminant with the conditioning agent until the conditioned solution reaches a substantially neutral colloidal charge and then scaling the amount of conditioning agent needed to cause the conditioned solution to reach a substantially neutral colloidal charge to account for the amount of liquid comprising a water-soluble contaminant to be treated in the electrochemical reactor.

3. The method of claim 1, wherein the contaminant is negatively charged in an aqueous solution with a pH greater than about 3, for example, greater than about 4, greater than about 5, and/or greater than about 6.

4. The method of claim 1, wherein the substantially neutral colloidal charge is determined when a streaming current value is between −30 mV and +30 mV.

5. The method of claim 1, wherein the substantially neutral colloidal charge is determined when a streaming current value is between −10 mV and +10 mV.

6. The method of claim 1, wherein the substantially neutral colloidal charge is determined when a streaming current value is between −5 mV and +5 mV.

7. The method of claim 1, wherein a colloidal charge is measured by a coagulant charge analyzer.

8. The method of claim 7, wherein the coagulant charge analyzer comprises a piston placed in an annular space through which the conditioned solution passes.

9. The method of claim 8, wherein the colloidal charge is measured by passing the conditioned solution through an electrode gap and applying a known electrical potential across the electrode gap and calculating a velocity of particles through a defined sensing zone.

10. The method of claim 1, wherein the conditioning agent comprises a conditioning agent chosen from one or more in the group of a coagulant, a polymer, and a surfactant.

11. The method of claim 10, wherein the conditioning agent comprises a positively charged polymer or a positively charged surfactant.

12. The method of claim 1, wherein the contaminant is highly water-soluble.

13. The method of claim 12, wherein the contaminant has a water solubility of greater than about 600 mg/l, greater than about 1000 mg/L, and/or greater than about 1500 mg/L.

14. The method of claim 1, wherein the contaminant comprises PFAS.

15. The method of claim 1, wherein the contaminant is chosen from one or more in the group of PCB, PAH, and PFAS.

16. The method of claim 1, wherein combining the liquid comprising a contaminant and the conditioning agent is carried out in a conditioning tank before delivering the conditioned solution to the flow-through electrochemical reactor.

17. The method of claim 16, wherein combining is carried out in the conditioning tank for a period of time between 30 seconds and 60 minutes, for example, between 2 minutes and 20 minutes.

18. The method of claim 1, wherein combining the liquid comprising a contaminant and the conditioning agent is carried out in a reactor tank including the flow-through electrochemical reactor, thereby preparing the conditioned solution in situ in the reactor tank including the flow-through electrochemical reactor.

19. An electrochemical contaminant remediation system comprising:
a conditioning tank including an untreated liquid input and a conditioning agent input, the conditioning tank being configured to accept untreated liquid comprising a water-soluble contaminant from the untreated liquid input and conditioning agent from the conditioning agent input such that the untreated liquid and the conditioning agent are combined in the conditioning tank to form a conditioned solution in the conditioning tank, the conditioned solution having a substantially neutral colloidal charge;
a conditioned fluid flow path fluidly connecting the conditioning tank to a flow-through electrochemical reactor, the conditioned fluid flow path being configured to accept the conditioned solution from the conditioning tank and to deliver the conditioned solution to the flow-through electrochemical reactor, the flow-through electrochemical reactor comprising:
a housing including an internal liquid flow-path;
a first electrode disposed within the internal liquid flow-path;
a second electrode spaced apart from the first electrode creating an electroactive gap between the first electrode and the second electrode, the flow-through electrode being configured to pass the conditioned solution through the electroactive gap and thereby electrochemically remediate the water-soluble contaminant.

20. The system of claim 19, wherein the conditioned solution comprises a colloidal charge of between −30 and +30.

21. The system of claim 19, wherein the conditioned solution comprises a colloidal charge of between −10 and +10.

22. The system of claim 19, wherein the conditioned solution comprises a colloidal charge of between −5 and +5.

23. The system of claim 19, further comprising a colloidal charge analyzer fluidly connected to the conditioning tank, the colloidal charge analyzer measuring the colloidal charge.

24. The system of claim 23, wherein the coagulant charge analyzer comprises a piston placed in an annular space through which the conditioned solution passes.

25. The system of claim 19, wherein the colloidal charge is measured by passing the conditioned solution through an electrode gap and applying a known electrical potential across the electrode gap and calculating a velocity of particles through a defined sensing zone.

26. The system of claim 19, wherein the conditioning agent comprises a conditioning agent chosen from one or more in the group of a coagulant, a polymer, and a surfactant.

27. The system of claim 26, wherein the conditioning agent comprises a positively charged polymer or a positively charged surfactant.

28. The system of claim 19, wherein the contaminant is highly water-soluble.

29. The system of claim 19, wherein the contaminant has a water solubility of greater than about 600 mg/l, greater than about 1000 mg/L, and/or greater than about 1500 mg/L.

30. The system of claim 19, wherein the contaminant comprises PFAS.

31. The system of claim 19, wherein the contaminant is chosen from one or more in the group of PCB, PAH, and PFAS.

32. An electrochemical contaminant remediation system comprising:
a reactor tank, the reactor tank including an untreated liquid input for accepting an untreated liquid comprising a water-soluble contaminant, a conditioning agent input fluidly connected to the reactor tank by a conditioning agent fluid flow path, the reactor tank being configured to accept untreated liquid comprising a water-soluble contaminant from the untreated liquid input and conditioning agent from the conditioning agent input such that the untreated liquid and the conditioning agent are combined in situ in the reactor tank to form a conditioned solution, the conditioned solution having a substantially neutral colloidal charge; and
a flow-through electrochemical reactor comprising:
a housing including an internal liquid flow-path;
a first electrode disposed within the internal liquid flow-path;
a second electrode spaced apart from the first electrode creating an electroactive gap between the first electrode and the second electrode; and the flow-through electrode being configured to pass the conditioned solution through the electroactive gap and thereby electrochemically remediate the water-soluble contaminant.
